(19) United States
(12) Patent Application Publication
(10) Pub. No.: US 2015/0015990 A1
(43) Pub. Date: Jan. 15, 2015

(54) HEAD STACK ASSEMBLY, HARD DISK DRIVE, AND METHOD OF CONNECTING A HEAD GIMBAL ASSEMBLY TO A FLEXIBLE PRINTED CIRCUIT ASSEMBLY IN A HEAD STACK ASSEMBLY

(71) Applicant: SAE Magnetics (H.K.) Ltd., Hong Kong (CN)

(72) Inventors: Sidney Shen Kuang Chou, Hong Kong (CN); Jackie Ka Yip Wong, Hong Kong (CN); Shu Deng, DongGuan (CN); Xin Zhong, DongGuan (CN); Lu Xiao, DongGuan (CN)

(73) Assignee: SAE Magnetics (H.K.) Ltd., Hong Kong (CN)

(21) Appl. No.: 14/022,579

(22) Filed: Sep. 10, 2013

(30) Foreign Application Priority Data
Jul. 15, 2013 (CN) 201310304024.1

(51) Int. Cl. G11B 5/48; G11B 19/20; G11B 21/02

(52) U.S. Cl. CPC G11B 5/4853; G11B 5/4873; G11B 5/4833; G11B 21/02; G11B 19/2009; G11B 5/4826
USPC 360/75; 29/603.06

(57) ABSTRACT

A head stack assembly includes at least one head gimbal assembly and a flexible printed circuit assembly. A flexure tail of the head gimbal assembly includes a row of first bonding pads, a first dual stage actuator pad and a first dummy pad arranged at two sides of said row of first bonding pads, and the first dual stage actuator pad and the first dummy pad are connected together via a jumping lead. The flexible printed circuit assembly includes at least one row of second bonding pads, at least one second dual stage actuator pad and at least one second dummy pad arranged for connecting with the row of first bonding pads, the first dual stage actuator pad and the first dummy pad respectively. The connection way between the head gimbal assembly and the flexible printed circuit assembly is simple, thereby less cross talk is generated on the preamplifier.

### FIELD OF THE INVENTION

The present invention relates to information recording disk drive devices and, more particularly to a head stack assembly (HSA), hard disk drive with the same, and a method of connecting a head gimbal assembly (HGA) to a flexible printed circuit assembly (FPCA) in an HSA.

### BACKGROUND OF THE INVENTION

Hard disk drives are information storage devices that use thin film magnetic media to store data. Referring to FIG. 1a, a typical hard disk drive 1 in prior art include s a head stack assembly (HSA) 10 with slider 11 (shown in FIG. 1b) thereon, a magnetic disk 12 mounted on a spindle motor 13 which causes the magnetic disk 12 to spin, and a motor base 14 to enclose the above-mentioned components.

The slider 11 flies over the surface of the magnetic disk 12 at a high velocity to read data from or write data to concentric data tracks on the magnetic disk 12, which is positioned radially by a voice coil 15 embedded (e.g. by epoxy potting or overmolding) in a fantail spacer 16 of the HSA 10. Generally, a voice coil motor (VCM) 16 is used to drive the voice coil 15.

Referring to FIG. 1b, a traditional HSA 10 includes an actuator coil assembly (ACA) 30, a fantail spacer 16 interposed in the ACA 30 via the voice coil 15, at least an HGA 20 connected with the ACA 30, and an FPCA 40 for controlling the HGA 20. The ACA 30 has at least one top surface 31 for mounting the HGA 20, and a side surface 32 for mounting the control FPCA 40.

As shown in FIG. 1b, the FPCA 40 includes a printed circuit board assembly (PCBA) 42a for connecting with a preamplifier (not shown) and a flexible printed circuitry (FPC) 42b connecting with the PCBA 42a. And the FPC 42b electrically connects to the HGA 20, and mounts on the side surface 32 of the ACA 30.

Concretely, as shown in FIG. 1c, the HGA 20 includes a suspension 210 and a slider 11 supported by the suspension 210. Concretely, the suspension 210 includes a load beam 216, a base plate 218, a hinge 217 and a flexure 215, all of which are assembled with each other. The flexure 215 runs from the hinge 217 to the load beam 216, which has a flexure tail 215a connecting with the FPC 42b. Conventionally, for further fine actuating writing and reading of the slider 11 on the suspension 210, at least one dual stage actuator (DSA) 22 (preferably two DSAs) is formed on the hinge 217 and connecting with the flexure 215. The DSAs 22 are needed to connect to the FPCA 40 for controlling as well as the multiple traces 224 on the suspension 210. Concretely, the two DSAs 22 are jointed at one DSA pad 221 on the flexure tail 215a, and then the DSA pad 221 is connected with the corresponding pad on the FPCA 40. In additional, multiple bonding pads 223 are formed on the flexure tail 215a for connecting with the FPC 42b via traces 224.

Traditionally, there are two connection ways to connect the HGA 20 with the FPCA 40. One is planar connection as shown in FIG. 2a, and the other is vertical connection as shown in FIG. 2b. Concretely, when the planar connection is performed in the HSA, all bonding pads (referring to FIG. 2c) on the flexure tail 215a is connected with the corresponding bonding pads on the FPC 42b′ with the plane of the flexure tail 215a parallel to the plane of the FPC 42b′ face to face. When several suspensions are included in the HSA, each DSA pad 222 can be connected with the corresponding DSA pad on the FPC 42b′ easily, and the total DSA pads 222 on the FPC 42b′ also can be connected together easily and connected to the other equipment. When the vertical connection is performed, it's necessary to form a slot 23 is on the FPC 42b. However it's difficult to connect DSAs of the suspensions to the DSA pads 222 on the FPC 42b if the DSA pads are arranged as shown in FIG. 2a, due to the existence of the slot 23. Thus, the traces of the conventional HSA are complicated, which causes much cross talk on the preamplifier, and in turn affects the performance of the hard disk drive. Obviously, the prior art can not meet the actual demand seriously.

Thus, there is a need for an improved HSA with DSA and hard disk drive, and an improved method of connecting an HGA to an FPCA in HSA with DSA that do not suffer from the above-mentioned drawbacks.

### SUMMARY OF THE INVENTION

One aspect of the present invention is to provide an HSA which the connection way between the HGA and the FPCA is simple with lower cost, thereby less cross talk is generated on the preamplifier.

Another aspect of the present invention is to provide a method of connecting an HGA to an FPCA in an HSA, which the connection way is simple with lower cost, thereby less cross talk is generated on the preamplifier, therefore the performance of the slider is improved.

Yet another aspect of the present invention is to provide a hard disk drive with an HSA, which the connection way between the HGA and the FPCA is simple with lower cost, thereby less cross talk is generated on the preamplifier, finally the performance of the hard disk drive is improved.

To achieve above objectives, an HSA of the present invention includes at least one HGA and an FPCA for controlling the HGA. The HGA has a suspension and a slider mounted thereon, and the suspension includes at least one DSA for actuating the slider, and a flexure tail connecting to the FPCA perpendicularly. Concretely, the flexure tail includes a row of first bonding pads connected with traces on the suspension, a first DSA pad and a first dummy pad arranged at two sides of said row of first bonding pads, the first DSA pad is connected with the DSA, and the first DSA pad and the first dummy pad are connected together via a jumping lead. And the FPCA includes at least one row of second bonding pads, at least one second DSA pad and at least one second dummy pad arranged for connecting with the row of first bonding pads, the first DSA pad and the first dummy pad respectively.

As an exemplary embodiment, at least one slot is formed on the FPCA, four said row of second bonding pads, four said second dummy pads and four said second DSAs are arranged on the FPCA, and the two said second dummy pads located at the same side of the slot are connected together, and the two said second DSA pads located at two different sides of the slot are connected together.

Preferably, the HSA includes four said HGAs.

Preferably, the suspension includes a load beam, a base plate, a hinge and a flexure having the flexure tail, and the suspension has two DSAs mounted on the hinge and connected with the flexure, and the two DSAs are connected with the first DSA pad on the flexure tail.

Preferably, the first dummy pad and the second dummy pads are made by conductive material.

Preferably, said first DSA pad, said row of first bonding pads and said first dummy pad are arranged in a line orderly, and said second DSA pad, said row of second bonding pads and said second dummy pad for one said suspension are arranged in a line orderly as well.

A method of connecting an HGA to an FPCA in an HSA of the present invention includes steps of:

providing at least one HGA with at least one DSA formed on a suspension of the HGA;

forming a row of first bonding pads connected with traces on a flexure tail of the suspension, a first DSA pad and a first dummy pad arranged at two sides of said row of first bonding pads, and the first DSA pad being connecting with the DSA; and

forming at least one row of second bonding pads, at least one second DSA pad and at least one second dummy pad on the FPCA, and connecting them with the row of first bonding pads, the first DSA pad and the first dummy pad respectively with the flexure tail and the FPCA are perpendicular each other.

As a preferable embodiment, the method further includes forming at least one slot on the FPCA, forming two said second dummy pads located at the same side of the slot and connected together, and forming two said second DSA pads located at two different sides of the slot and connected together.

Preferably, the first dummy pad and the second dummy pads are made by conductive material.

Preferably, said first DSA pad, said row of first bonding pads and said first dummy pad are arranged in a line orderly, and said second DSA pad, said row of second bonding pads and said second dummy pad for one said suspension are arranged in a line orderly as well.

A hard disk drive of the present invention includes a motor base, a disk stack including at least one disk, a spindle motor being attached to the motor base for rotating the disk stack, and an HSA. The HSA includes at least one HGA and an FPCA for controlling the HGA. The HGA has a suspension and a slider mounted thereon, and the suspension includes at least one DSA for actuating the slider, and a flexure tail connecting to the FPCA perpendicularly. Concretely, the flexure tail includes a row of first bonding pads connected with traces on the suspension, a first DSA pad and a first dummy pad arranged at two sides of said row of first bonding pads, the first DSA pad is connected with the DSA, and the first DSA pad and the first dummy pad are connected together via a jumping lead. And the FPCA includes at least one row of second bonding pads, at least one second DSA pad and at least one second dummy pad arranged for connecting with the row of first bonding pads, the first DSA pad and the first dummy pad respectively.

Compared with the prior art, the DSA of the HGA of the present invention can connect to the FPCA with several dummy pads and DSA pads, so that the traces on the HGA and the FPCA are simplified, thus the manufacturing cost is reduced, meanwhile the cross talk generated on the preamplifier is reduced due to the simple traces design.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective exploded view of a conventional hard disk drive;

FIG. 1b is a perspective exploded view of a HSA of the hard disk drive shown in FIG. 1a;

FIG. 1c shows a conventional HGA;

FIG. 2a is a top view of the partial FPCA according the conventional planar connection;

FIG. 2b is a top view of the partial FPCA according the conventional vertical connection;

FIG. 2c is a top view of the flexure tail of the conventional HGA;

FIG. 3 is a perspective view of an HSA according to an embodiment of the present invention;

FIG. 4 is an perspective exploded view of the HSA shown in FIG. 3;

FIG. 5 is a perspective view of HGAs of the HSA shown in FIG. 4;

FIG. 6 is a top view of one said HGA shown in FIG. 5;

FIG. 7 is a top view of the flexure tail of the HGA shown in FIG. 6;

FIG. 8 is a top view of the FPC of the PFCA;

FIG. 9 is a flow chart that shows a method of connecting an HGA to an FPCA in an HSA according to one embodiment of the present invention; and

FIG. 10 shows a hard disk drive according to one embodiment of the present invention.

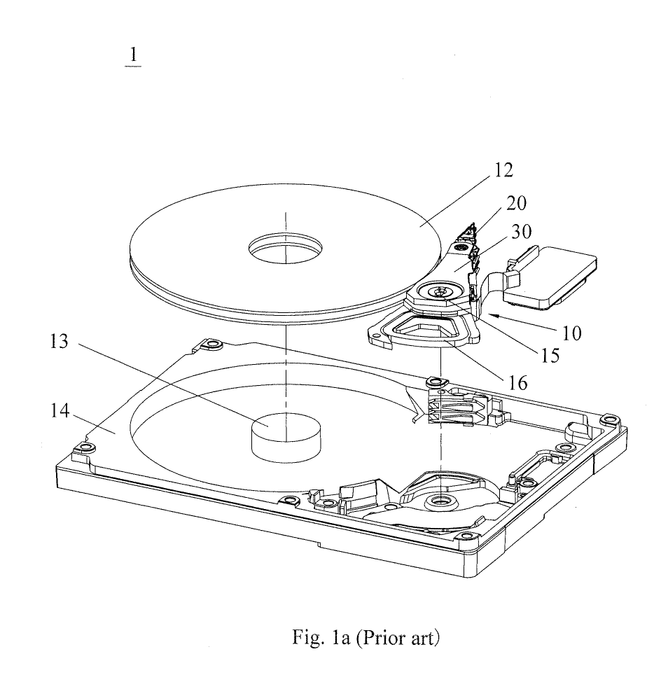

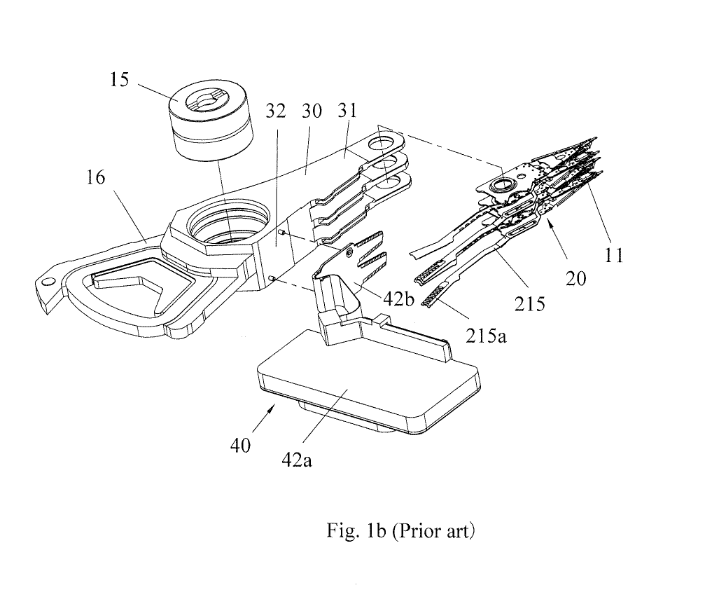

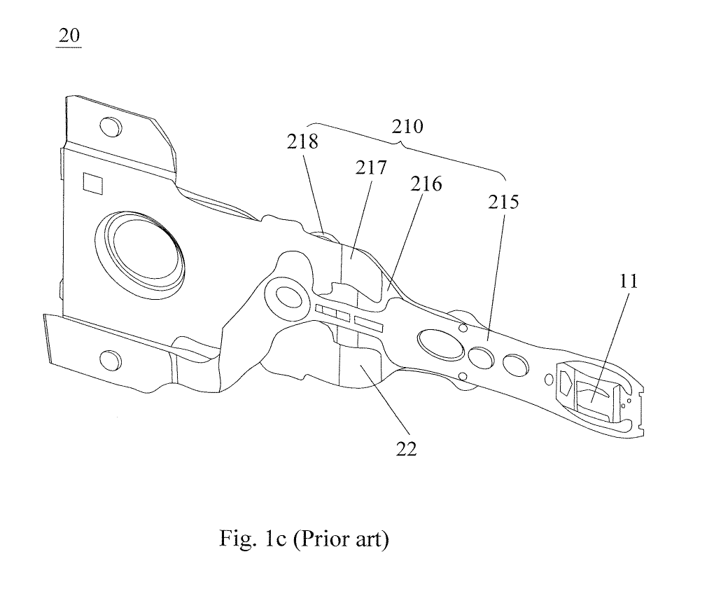

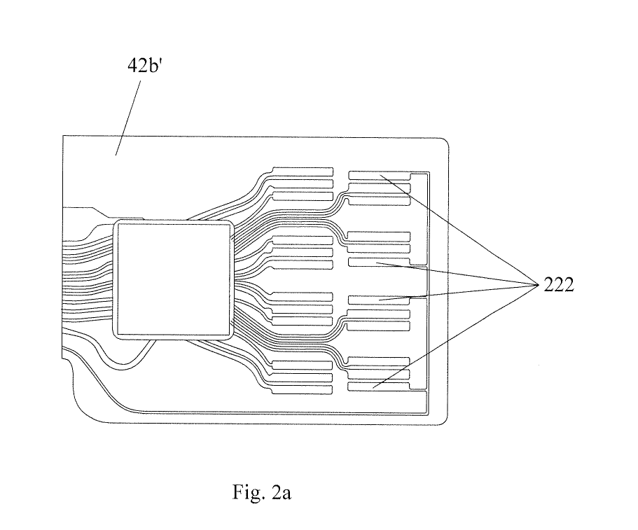

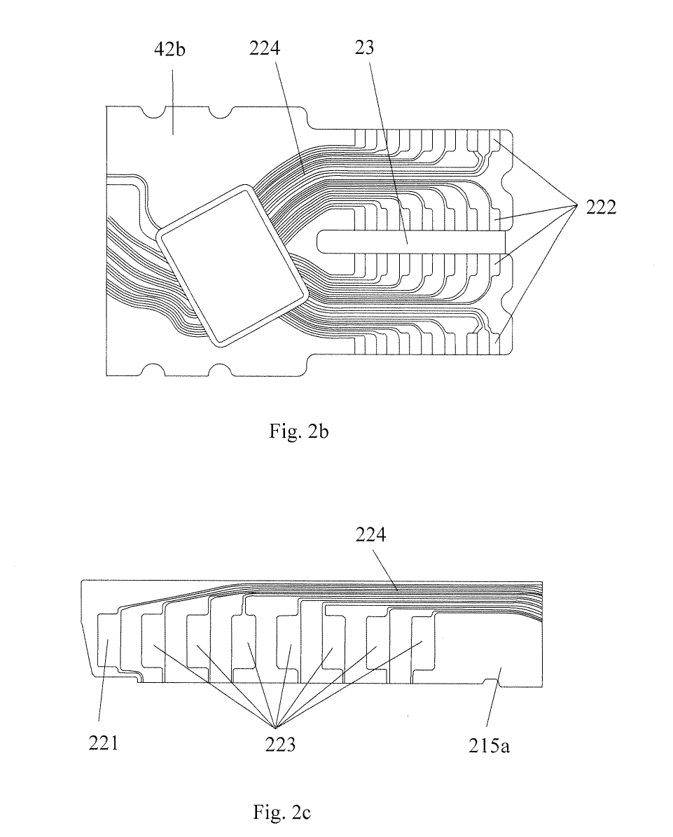

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to an HSA and a method of connecting an HGA to an FPCA, whose connection way is simple with low cost, and cross talk generated on the preamplifier is reduced. Specially, the present invention is adapted to the HSA which the plane of the flexure tail of the HGA is perpendicular to the plane of the FPC of the FPCA.

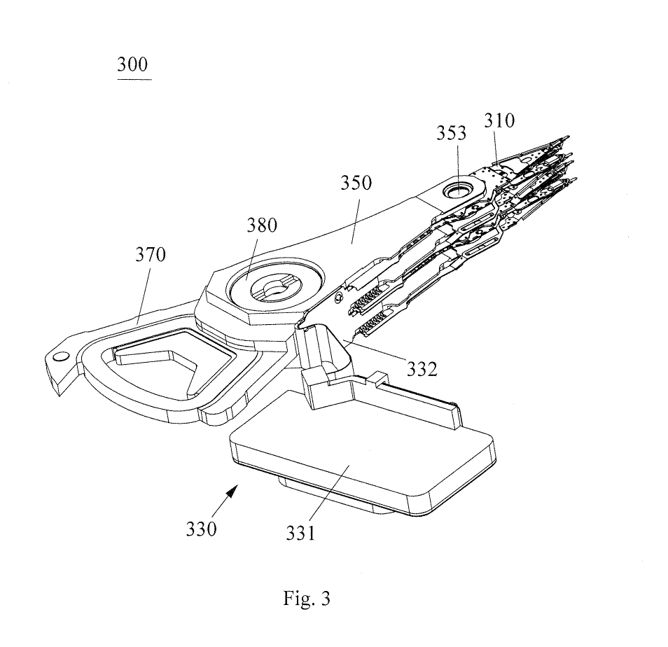

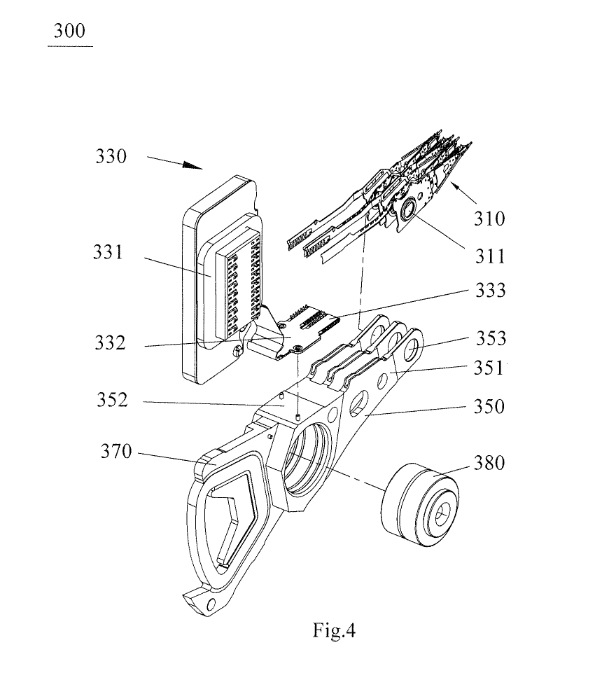

FIGS. 3-4 respectively show a perspective view and an exploded view of an HSA 300 accordingly to an embodiment of the present invention. As illustrated, the HSA 300 includes several HGAs 310, such as four, an FPCA 330 for controlling the HGAs 310, an ACA 350 and a fantail spacer 370. Concretely, the ACA 350 includes at least one top surface 351 for mounting the HGAs 310, and a side surface 352 for mounting the FPCA 330. Concretely, the HGAs 310 connect with the ACA 350 by aligning holes 311 and 353, the fantail spacer 370 couples to the ACA 350 via a bearing 380. The FPCA 330 includes a PCBA 331 for connecting with the preamplifier (not shown) and a FPC 332 connecting with the PCBA 331. The FPC 332 has a connection region 333 for attaching to the side surface 352 of the ACA 350. More specifically, the connection region 333 is arranged for connecting with the HGAs 310 for controlling the HGAs 310. The more detailed description will be presented hereinafter.

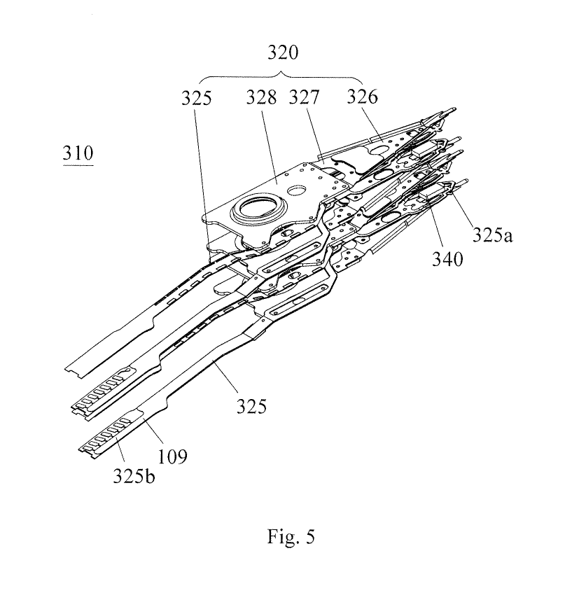

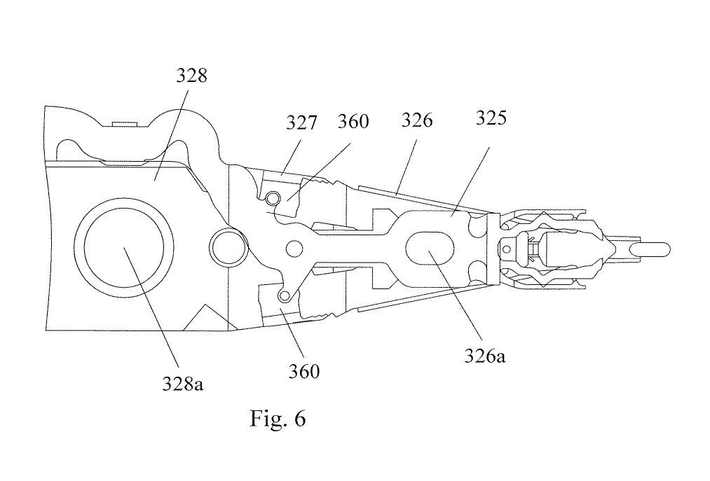

FIG. 5 shows structure view of the HGAs 310 of the HSA 300 shown in FIG. 4. As shown in FIG. 5, each HGA 310 includes a suspension 320 and a slider 340 supported by the suspension 320. Concretely, the suspension 320 includes a load beam 326, a base plate 328, a hinge 327 and a flexure 325, all of which are assembled with each other. The flexure 325 runs from the hinge 327 to the load beam 326, as shown in FIG. 6.

Concretely, the load beam 326 is used to transfer load forces to the flexure 325 and the slider 340 mounted on the flexure 325. Any suitable rigid material such as stainless steel may be used to form the load beam 326 such that the load beam 326 has sufficient stiffness to transfer the load forces to the flexure 325. The load beam 326 is connected to the base plate 328 by the hinge 327. A locating hole 326a is formed on the load beam 326 for aligning itself with the flexure 325. A dimple (not shown) is formed on the load beam 326 to support the flexure 325 at a position corresponding to a center of the slider 340. By this engagement of the dimple with the flexure 325, the load forces can be transferred to the slider 340 uniformly.

The base plate 328 is used to enhance structure stiffness of the whole suspension 320 and may be made of rigid material such as stainless steel. A mounting hole 328′ is formed on one end of the base plate 328 for mounting the whole suspension 320 to a motor arm of a hard disk drive.

The hinge 327 and the base plate 328 may be mounted together by laser welding at a plurality of pinpoints distributed on the hinge 207. As shown in FIG. 6, two DSAs 360 are formed on the hinge 327 and connected with the flexure 325 with located at two sides of the flexure 325, for further controlling the movement of the slider 340.

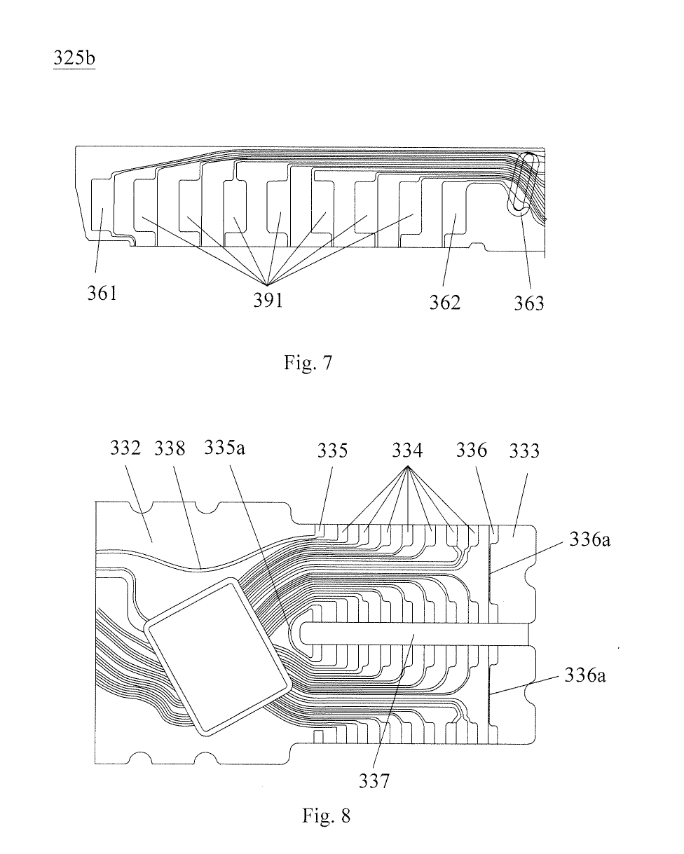

The flexure 325 runs from the hinge 327 to the load beam 326. The flexure 325 has a flexure head 325a extending to the slider 340 and a flexure tail 325b extending to connect with the FPCA 330. Multiple traces are extended from the flexure head 325a to the flexure tail 325b. Referring to FIG. 7, the flexure tail 325b includes a connection portion which has a row of first bonding pads 391 for connecting with the traces, a first DSA pad 361 arranged at one side of the row of first bonding pads 391 for connecting with the DSAs 360, and a first dummy pad 362 arranged at the other side of the row of first bonding pads 391. Namely, the row of first bonding pads 391 is configured between the first DSA pad 361 and the first dummy pad 362. Concretely, the first DSA pad 361 is connected with the first dummy pad 362 via a jumping lead 363. Concretely, the first DSA pad 361, the row of first bonding pads 391 and the first dummy pad 362 are arranged in a line orderly. Concretely, the first dummy pad 362 is made by conductive material.

Accordingly, as mentioned above, the FPC 332 of the FPCA 330 has a connection region 333 for attaching to the side surface 352 of the ACA 350, as shown in FIG. 8. The connection region 333 includes at least one row of second bonding pads 334, at least one second DSA pad 335 and at least one second dummy pad 336 arranged thereon, for connecting with the row of first bonding pads 391, the first DSA pad 361 and the first dummy pad 362 respectively. Concretely, the amount of the row of second bonding pads 334, the second DSA pad 335 and the second dummy pad 336 varies with the amount of the HGA 310. In this embodiment, the amount of the HGA 310 is four, accordingly the pads includes four rows as shown in the FIG. 8.

Preferably, a slot 337 is formed on the FPC 332, and two of the second dummy pads 336 located at the same side of the slot 337 are connected together via a trace 336a, and two of the second DSA pads 335 located at two different sides of the slot 337 are connected together via traces 335a. One of the second dummy pads 336 is connected to other equipment via a trace 338.

When connecting the HGAs 310 with the FPCA 330, each HGA 310 is placed adjacent to the FPCA 330. Concretely, the flexure tail 325b of the HGA 310 is placed perpendicularly to the plane of the FPC 332, with each of the first DSA pads 361 is aligned with the corresponding second DSA pads 335, the row of first bonding pads 391 is aligned with the row of second bonding pads 334, and the first dummy pad 362 is aligned with the second dummy pad 336, and then bonding the above-mentioned pads by welding or other bonding ways.

Based on the connection ways, as each of the first DSA pads 361 is connected with each of the first dummy pads 362 via the jumping lead 363 respectively, the two said second DSA pads 335 at the two sides of the slot 337 are connected together, the two said second dummy pads 336 at the same side of the slot 337 are connected together, and one of the second DSA pad 335 is connected to the preamplifier, thus four said second DSA pads are connected with the four DSAs 360, so that the combination and the connection along the four HGAs 310 are achieved. This connection way is suitable for vertical connection, and the connection way is simple with low cost, and cross talk generated on the preamplifier is reduced.

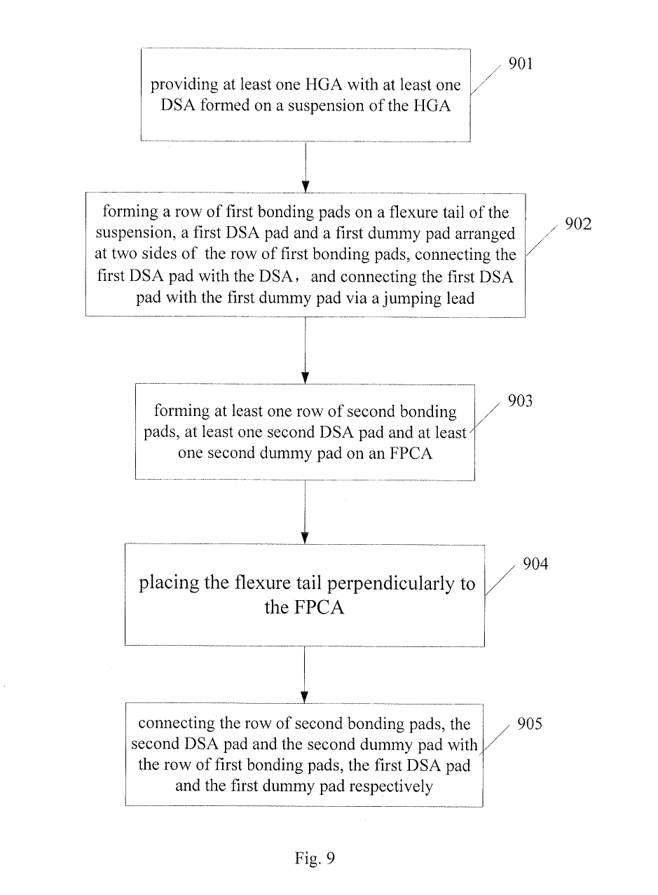

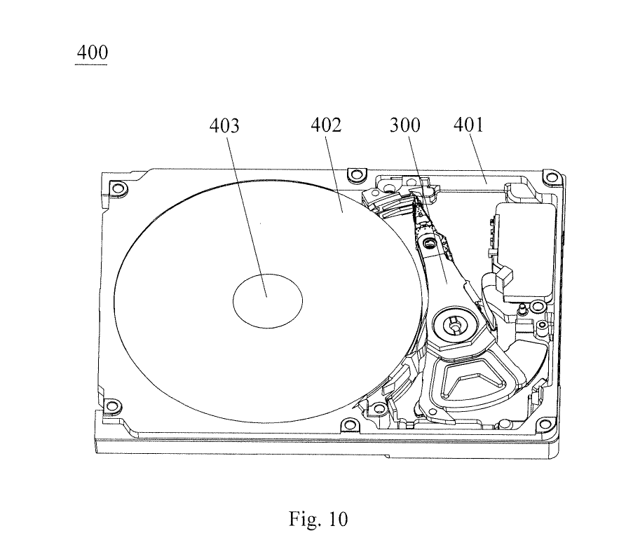

Turning now to FIG. 9, a method of connecting an HGA to an FPCA in an HAS 1000 according to one embodiment of the present invention is shown, which includes steps of:

Step (901), providing at least one HGA with at least one DSA formed on a suspension of the HGA;

Step (902), forming a row of first bonding pads on a flexure tail of the suspension, a first DSA pad and a first dummy pad arranged at two sides of the row of first bonding pads, connecting the first DSA pad with the DSA, and connecting the first DSA pad with the first dummy pad via a jumping lead;

Step (903), forming at least one row of second bonding pads, at least one second DSA pad and at least one second dummy pad on an FPCA;

Step (904), placing the flexure tail perpendicularly to the FPCA; and

Step (905), connecting the row of second bonding pads, the second DSA pad and the second dummy pad with the row of first bonding pads, the first DSA pad and the first dummy pad respectively.

As a preferable embodiment, the method further includes forming at least one slot on the FPCA, forming two said second dummy pads located at the same side of the slot and connected together, and forming two said second DSA pads located at two different sides of the slot and connected together.

Comparing with the prior art, the method of connecting an HGA to an FPCA according to the present invention can connect the HGA to the FPCA perpendicularly with the connection way is simple and easy, which causes cross talk generated on the preamplifier is reduced, and in turn improve the performance of the HSA.

FIG. 10 shows a hard disk drive 400 according to one embodiment of the present invention. The hard disk drive 400 includes a motor base 401, a disk stack comprising at least one disk 402, a spindle motor 403 being attached to the motor base 401 for rotating the disk stack, and an HSA 300. As described above, the HSA 300 includes all features and advantages that have been recorded thereinbefore according the present invention. In addition, as the structure and/or assembly process of hard disk drive 400 of the present invention are well known to persons ordinarily skilled in the art, a detailed description of such structure and assembly is omitted herefrom.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A head stack assembly, comprising at least one head gimbal assembly and a flexible printed circuit assembly for controlling the head gimbal assembly, the head gimbal assembly having a suspension and a slider mounted thereon, the suspension including at least one dual stage actuator for actuating the slider, and a flexure tail connecting to the flexible printed circuit assembly perpendicularly;
wherein the flexure tail comprises a row of first bonding pads connected with traces on the suspension, a first dual stage actuator pad and a first dummy pad arranged at two sides of said row of first bonding pads, the first dual stage actuator pad is connected with the dual stage actuator, and the first dual stage actuator pad and the first dummy pad are connected together via a jumping lead;
and the flexible printed circuit assembly comprises at least one row of second bonding pads, at least one second dual stage actuator pad and at least one second dummy pad arranged for connecting with the row of first bonding pads, the first dual stage actuator pad and the first dummy pad respectively.

2. The head stack assembly according to claim 1, wherein at least one slot is formed on the flexible printed circuit assembly, four said row of second bonding pads, four said second dummy pads and four said second dual stage actuator pads are arranged on the flexible printed circuit assembly, and the two said second dummy pads located at the same side of the slot are connected together, and the two said second dual stage actuator pads located at two different sides of the slot are connected together.

3. The head stack assembly according to claim 2, comprising four said head gimbal assemblies.

4. The head stack assembly according to claim 1, wherein the suspension comprises a load beam, a base plate, a hinge and a flexure having the flexure tail, and the suspension has two dual stage actuators mounted on the hinge and connected with the flexure, and the two dual stage actuators are connected with the first dual stage actuator pad on the flexure tail.

5. The head stack assembly according to claim 1, wherein the first dummy pad and the second dummy pads are made by conductive material.

6. The head stack assembly according to claim 1, wherein said first dual stage actuator pad, said row of first bonding pads and said first dummy pad are arranged in a line orderly.

7. The head stack assembly according to claim 6, wherein said second dual stage actuator pad, said row of second bonding pads and said second dummy pad for one said suspension are arranged in a line orderly as well.

8. A method of connecting a head gimbal assembly to a flexible printed circuit assembly in a head stack assembly comprising steps of:
providing at least one head gimbal assembly with at least one dual stage actuator formed on a suspension of the head gimbal assembly;
forming a row of first bonding pads on a flexure tail of the suspension, a first dual stage actuator pad and a first dummy pad arranged at two sides of said row of first bonding pads, connecting the first dual stage actuator pad with the dual stage actuator, and connecting the first dual stage actuator pad with the first dummy pad via a jumping lead; and
forming at least one row of second bonding pads, at least one second dual stage actuator pad and at least one second dummy pad on a flexible printed circuit assembly;
placing the flexure tail perpendicularly to the flexible printed circuit assembly; and
connecting the row of second bonding pads, the second dual stage actuator pad and the second dummy pad with the row of first bonding pads, the first dual stage actuator pad and the first dummy pad respectively.

9. The method according to claim 8, further comprising forming at least one slot on the flexible printed circuit assembly, forming two said second dummy pads located at the same side of the slot and connected together, and forming two said second dual stage actuator pads located at two different sides of the slot and connected together.

10. The method according to claim 8, the first dummy pad and second dummy pads are made by conductive material.

11. The method according to claim 8, wherein arranging said first dual stage actuator pad, said row of first bonding pads and said first dummy pad in a line orderly.

12. The method according to claim 11, wherein arranging said second dual stage actuator pad, said row of second bonding pads and said second dummy pad for one said suspension in a line orderly as well.

13. A hard disk drive, comprising:
a motor base;
a disk stack comprising at least one disk;
a spindle motor being attached to the motor base for rotating the disk stack; and
a head stack assembly, comprising at least one head gimbal assembly and a flexible printed circuit assembly for controlling the head gimbal assembly, the head gimbal assembly having a suspension and a slider mounted thereon, the suspension including at least one dual stage actuator for actuating the slider, and a flexure tail connecting to the flexible printed circuit assembly perpendicularly;
wherein the flexure tail comprises a row of first bonding pads connected with traces on the suspension, a first dual stage actuator pad and a first dummy pad arranged at two sides of said row of first bonding pads, the first dual stage actuator pad is connected with the dual stage actuator, and the first dual stage actuator pad and the first dummy pad are connected together via a jumping lead;
and the flexible printed circuit assembly comprises at least one row of second bonding pads, at least one second dual stage actuator pad and at least one second dummy pad arranged for connecting with the row of first bonding pads, the first dual stage actuator pad and the first dummy pad respectively.
